(19) United States
(12) Patent Application Publication
(10) Pub. No.: US 2001/0037362 A1
(43) Pub. Date: Nov. 1, 2001

(54) Automation system for solving a technical-process task and corresponding method

(76) Inventor: Gerhard Maitz, Graz (AT)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 09/865,011

(22) Filed: May 24, 2001

Related U.S. Application Data
(63) Continuation of application No. PCT/AT99/00286, filed on Nov. 23, 1999.

(30) Foreign Application Priority Data
Nov. 24, 1998 (AT) A 1972/98

(51) Int. Cl. G06F 15/16; G06F 9/44

(52) U.S. Cl. 709/203; 709/315

(57) ABSTRACT

The invention describes an automation system for solving a process-related task definition or at least for operating a technical system, in particular an industrial plant, by means of a computer system which, in at least one field level having field bus components and automation devices, can be broken down into a control level with at least one server and a client level having one or more client computers. An automation category, in particular for system objects such as motors, valves or also part-processes, is developed in a standard context for different types of automation elements of the automated task. The automation category is built on the one hand on server-related data elements and on the other on client-related data elements. An automation element is compiled from server-related data elements, client-related data elements and functions.

### CROSS-REFERENCE TO RELATED APPLICATION

The present application is a continuation of International Application PCT/AT99/00286, filed Nov. 23, 1999.

### FIELD OF THE INVENTION

The invention relates to an automation system and a method of solving an automated task definition.

### BACKGROUND OF THE INVENTION

To date, the various aspects of an automated task have been solved under very differing environmental conditions. For example, the control element was preferably managed using means dictated by the technical design of special automation devices or programmable logic controllers (PLCs). The display element and user interface additionally needed in many cases to solve the automated tasks were overlaid on the control element and these elements were required to exchange basic data with the control element. Furthermore, the display element and the user interface also worked together, both physically in the form of hardware and from a processing point of view through the various programming processes, in a different way than the control element. The data-related elements such as the data input and data evaluation were also overlaid on the control element along with the display. The disadvantage of this approach is the complicated way in which the individual automation elements work together in solving the task as a whole, increasing the complexity of the system overall and making subsequent housekeeping and maintenance chores considerably more difficult.

EP 0 825 506 A2 describes a remotely controllable automation system for operating a client/server configuration, in which software objects are used and whereby data can be communicated between the client and server computers across the Internet or an intranet. To this end, the client computers have what is referred to as an information client, in particular an Internet Web browser, which is capable of requesting and downloading from the server smaller program modules used in the context of a larger application for specific, limited purposes. The information client or corresponding Web browser can be run independently of hardware and independently of operating system. This being the case, the client runs the program module within a virtual machine environment so as to configure the client computer as process controller. This enables communication across the extensive network or Internet and the remote process can be monitored and controlled via these communication routes. However, with this system, although automation of the technical process can be remotely controlled, functional coordination of the various automation elements enabling an automated task definition to be solved in a standard context is not possible, nor does this known system point in this direction.

WO 91/19237 A1 discloses graphical programming methods for developing programs in graphical High-Level languages prior to compiling the programs into a file and transferring it for use in control systems for industry and business. The programming methods contain process, hardware and program operating functions for determining both process and hardware I/O points and linking these to variables in a control program. Although this pre-set system permits graphic-oriented programming, the data elements of this known system are not split up into different hardware levels, nor does this known system suggest doing so.

WO 97/26587 A1 also relates to an automation device and an automation system built using this automation device, making it possible to operate and control a technical process worldwide. Software function modules designed on an object-oriented basis are provided, which can be loaded into the automation device across the Internet and an Internet communications interface cooperating therewith. This automation device also has a sequencing system for the software function modules in order to integrate individual object-oriented software function modules and process the control program. Although it discloses an automation device suitable for use in a globally distributed automation unit, WO 97/26587 A1 does not make any mention of solving an automated task definition with all the requisite automation elements within a standard overlay and splitting the respective data elements into different hardware levels.

The objective of the present invention is to simplify the task of solving an automated task definition.

### SUMMARY OF THE INVENTION

The above needs are addressed and other advantages are achieved by the present invention, which provides an automation system and method for use in conjunction with a computer system which, in at least one field level with field bus components and automation devices, is broken down into a control level having at least one server and a client level having one or more client computers. The apparatus and method are characterized in that one or more automation categories, namely physical system objects such as motors, valves, etc., and/or part-processes, and functions that incorporate these system objects/processes in a process-related sequence, are developed within one standard context for different types of individual automation elements of the automated task to be performed. The automation elements can include a control, alarm system, display, user interface, etc. Each automation category is developed on the basis of server-related data elements and client-related elements, and an automation element is compiled using server-related elements, client-related elements, and function elements that are configured so as to optimize the requirements of the particular automation element. The invention enables the automation elements to be coordinated in a functional approach which is no longer data-related. As a result, elements of solutions are generated more on a problem- and process-related basis. Another significant advantage is the fact that the features that have previously been required for integrating separate integrators which combine the individual automation elements into an overall project are no longer necessary. Furthermore, provision is made for a preventive shut-down in the event of any data-related inconsistencies. Yet another significant advantage is the fact that a standard overlay can be used for all parts of the programming and configuration system, which means that hardly any inputting time is needed to set up the different automation elements. The overlay for all programming and configuration elements can therefore be structured independently of the devices and components used.

The automation system in accordance with the invention and the method used in conjunction with it provide an instrument for specialists in different fields, who can now package their specific knowledge in complete modules, as well as users who are not skilled in predefined automation categories.

Since the automation categories contain only problem-related rather than system-specific elements, automation categories can be substituted or imported in a simple manner. The automation categories can be defined through their programmed intelligence in existing environments. The defined template-based solution to problem-solving and the automated integrity of the solution and encapsulation of program details enable the automation categories to be used or distributed in an easy manner. Furthermore, support is provided for setting up more complex automation categories based on existing automation categories, which necessarily renders the transition from mainly technical or management programming very much smoother Other advantageous embodiments and features are set forth in the following detailed description of preferred embodiments of the invention.

### BRIEF DESCRIPTION OF THE DRAWINGS

The above and other objects, features, and advantages of the invention will become more apparent from the following description of certain preferred embodiments thereof, when taken in conjunction with the accompanying drawings in which:

FIG. 1 is a highly simplified, schematic diagram of the structure of an automation system in accordance with one preferred embodiment of the invention, broken down into the individual system levels;

FIG. 2 shows the development of an automation category, symbolising the standard context for the different automation elements;

FIG. 3 shows typical automation elements of an automated task broken down into main and subsidiary aspects;

FIG. 4 shows the timing system of an automation category and the breakdown of an automation category into server and client elements.

### DETAILED DESCRIPTION OF PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

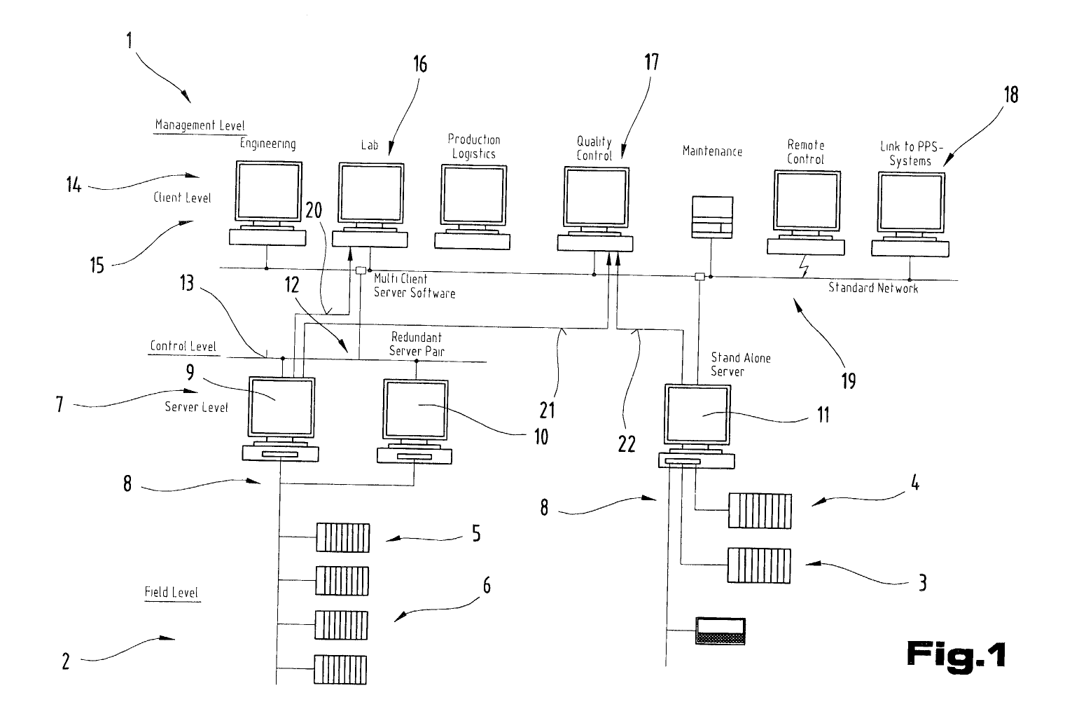

FIG. 1 illustrates an automation system 1 designed largely to automate operation of a technical system for sequencing a process in industry, for example in the chemical industry.

The automation system 1 is basically divided into three levels. The lowest level is the field level 2, which comprises standard automation devices 3, 4 primarily in the form of what are known as programmable logic controllers and, alternatively or in combination therewith, at least one interface module 5, 6 with several electrical inputs and/or outputs.

The inputs and/or outputs of the interface modules 5, 6 of the automation devices 3, 4 provide an electrical connection to a sensor and/or actuator level of the technical process, which is not illustrated. The electrical connection between the field level 2 and a higher control level 7 relating to the graphics is preferably provided in the form of known field bus systems 8, such as an interbus or profibus or the like.

The control level 7 comprises at least one electronic server 9, 10, 11. At least one of the servers 11 may be operated as a stand alone server, whilst the other servers 9, 10 may operate in conjunction with one another as a redundant server pair 12. The redundant server pair 12 is provided so that if one of the servers 9 or 10 of the server pair 12 fails, the other server 9 or 11 is able to take over the tasks of the failed server 9 or 11, as far as possible without interruption, thereby ensuring that the technical process is kept running. The servers 9, 10, 11 preferably have appropriate interface cards so as to be able to communicate with the components of the field level 2.

At least the servers 9, 10 of the server pair 12 in the control level 7 have a communication link via a network 13 for transferring data.

The individual software-controlled servers 9, 10, 11 are in turn connected by cabling or alternatively wirelessly to a higher graphics-based management level 14 so as to be able to communicate with one another or transfer control and/or process data.

The management level 14 may be likened to a client level 15, comprising several program-controlled client computers 16, 17, 18. A plurality of management or control functions, for example relating to development, production logistics, quality control, maintenance, remote control and the like, may be performed via these client computers 16 to 18.

The clients 16 to 18 are connected so that they can communicate with one another via a standard network 19. By preference, the standard network 19 for the client computers 16 to 18 in the management level 14 is conductively coupled with the aforementioned network 13 of the control level 7 to enable data to be transferred between the standard network 19 of the management level 14 and the network 13 of the control level 7.

Similarly, the standard network 19 may span at least certain parts of the control level 7 and accordingly integrate in particular the largely autonomous server 11.

Preferably, there are also individual direct links 20 to 22 between specific servers 9 to 11 and specific clients 16 to 18, the direction of communication or data transfers on the direct links 20 to 22 being defined from the servers 9 to 11 to the clients 16 to 18. These direct links 20 to 22 enable the servers 9 to 11 selectively to transfer data directly in the management level 14, the direct links 20 to 22 being predominantly used for transferring data or messages of a higher priority.

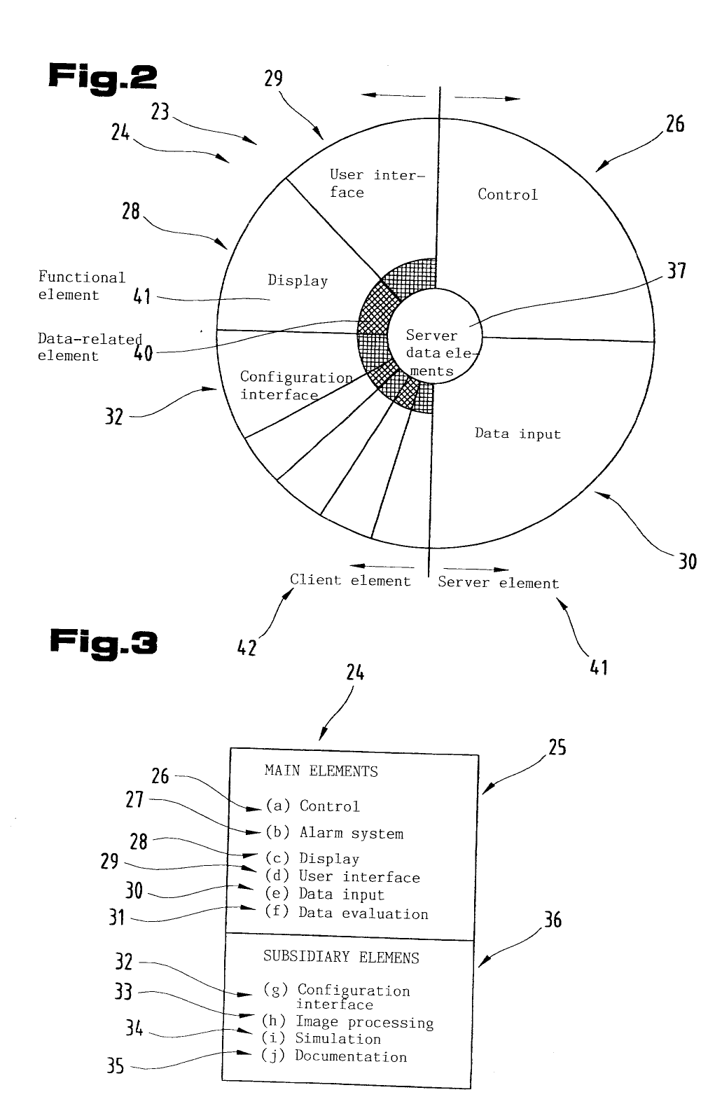

FIG. 2 illustrates how automation categories 23 are developed with a view to evaluation in an automation system of the type described above, as proposed by the invention. The sector-based compilation of individual automation elements 24 relating to an automated task as set out in the tabular presentation of FIG. 3, representing an effectively closed loop, illustrates the way in which the different automation elements 24 for the automation categories 23 are compiled in a standard context for application in an automation system. In particular, it symbolises the method proposed by the invention whereby the various aspects or automation elements 24 of an automated task are resolved in a standard context.

An automated task may be specifically broken down into one or more automation elements 24—as illustrated in FIG. 3. The main elements 25 primarily include a control system 26, an alarm system 27, a display 28, a user interface 29, a data input 30 and/or a data evaluation system 31.

Other automation elements 24 of an automated task may be defined via a configuration interface 32, an image processing system 33, a simulation 34 and/or by documentation 35, the latter automation element 24 often representing a subsidiary part 36 of the automated task.

The various automation elements 24 will have higher or lower profiles, depending on the task definition. When defining more minor and predominantly unsupervised process-related task definitions, e.g. for a clearing system, the element relating to the control system 26 is dominant whereas with relatively more complex processes, such as those used in the chemical industry for example, the display 28, the alarm system 27 and the user interface 29 will be of more critical importance.

In the case of tasks defined in relation to production processes, such as in the automotive industry for example, the automation elements 24 relating to data input 30 and data evaluation 31 for the purposes of production logistics, quality control and reproduction will take precedence.

The automation system proposed by the invention and the method steps underlying it enable several of the aforementioned automation elements 24 inherent in defining a task to be solved in a standard context.

To this end, the entire technical side of task definition is solved on a template basis in what is referred to as an object prototype or in an automation category 23. The entire process may be described as being the development of an automation category 23.

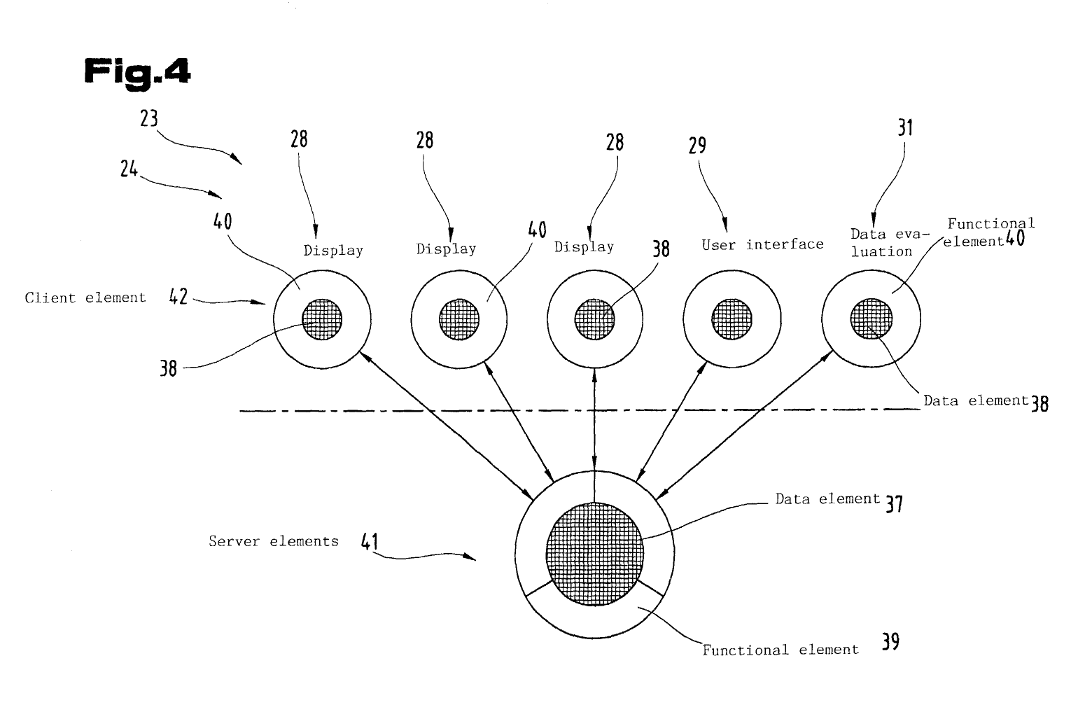

The first step in this development process is to set up a data record specific to the category. In addition to control data, data relating to the display 28, data for the user interface 29 and/or data input 30 are also defined. By data for the display 28 is meant, for example, the choice of color, graphics, character attributes and the like. The user interface 29 may be defined by means of switches, push sticks, editable text fields and the like. For the data input 30, tables and data bank components, for example, are defined. The key point is that all parts of the category-specific data record to be set up are defined within the context of the resultant automation category 23. Another key feature is that categorization is effected on the basis of server-related data elements 37 and client-related data elements 38, as illustrated more clearly in FIG. 4. The server-related or client-related data elements 37, 38 will be incorporated by reference to the different automation elements 24 and various device types on which the individual automation elements 24 will subsequently be executed or run. The category-specific data record is preferably set up in graphical and/or text format.

The next step in developing an automation category 23 is to incorporate the functions. The functions of the resultant automation category 23 duly relate to the data record defined in the first step and are also adapted to the different automation elements 24 illustrated in FIG. 3. Again, the key feature is that all server- or client-related function elements 39, 40 of the automated task are solved within the context of the resultant automation category 23. Another important feature is the fact that categorization is applied or maintained on the basis of server-related function elements 39 and client-related function elements 40, as may be seen more clearly from FIG. 4. The functions or function elements 39, 40 are produced by means of graphic and/or text mechanisms, each of which is optimized to suit the requirements of a specific automation element 24. These mechanisms are based on IEC 1131-3 and not only as stipulated for the control system 26 but also with regard to the display 28, the data input 30 and at least some of the other automation elements 24.

An automation category 23 created in steps in accordance with the aforementioned guidelines is then issued as a publication in a library and can therefore be made accessible to other users. Accordingly, different automation categories 23 can be made accessible on at least a company-wide basis, e.g. via an intranet link or alternatively providing coverage for several sites via global data communication facilities such as the Internet, for example.

A real project earmarked for automation will be made up one or more individual copies of one or more automation categories 23. Each copy of each object is an accurately detailed diagram of the automation category 23 in the sense that exclusively the structure of the data record and the functions of the respective automation category 23 are retained. However, every data record or every object is individual and can be addressed individually.

The individual copies or objects are linked to real projects using exclusively the same means as were used to define or create the automation category 23. As a result, and optionally with the support of a few additional means, the automation elements 24 for specific projects or process-related task definitions can in turn be incorporated to form automation categories 23. Accordingly, automation categories 23 represent not only physical objects, such as motors, valves, containers, but also whole processes or part-processes.

As may be seen more particularly from FIG. 2, the control system 26 or control element forms a server-related element or server element 41 of an automation category 23. Normally, the automation element 24 relating to the data input 30 is therefore a server-related element or server element 41 of an automation category 23. In individual instances, e.g. when logging user actions or actions initiated by users, there will also be client-related elements or client elements 42.

At least some of the remaining automation elements 24, e.g. the user interface 29, the display 28 and/or the configuration interface 32 are client-related elements or client elements 42 of an automation category 23.

If an automation category 23 contains automation elements 24 relating to data evaluation 31 and documentation 35, these automation elements 24 are categorised as client-related elements or client elements 42.

In principle, it should be pointed out that the server elements 41 of an automation category 23 or an object are permanent features. The client elements 42, on the other hand, are created or deleted as required and preferably for the specific running time. The client elements 42 of an automation category 23 may—as is particularly clear from FIG. 4—exist on a multiple basis and simultaneously. As they are created and preferably for the running time of the automation category 23, they are linked to the existing server element 41. There is only one server element 41 per automation category 23 or object and it is generated at the time the object is created or the automation category 23 is created.

As may be seen in particular from FIG. 2, the server-related data elements 37 are available for the functions of all automation elements 24.

A category-specific data record is created in accordance with international standard IEC 1131. In particular, the corresponding basic data types, the generic data types and variable declarations are supported.

In the automation system proposed by the invention, the elementary data types, which are predominantly needed for the control element 26, are completed by elements of the alarm system 27, the display 28, the user interface 29, the configuration interface 32, the data input 30, the data evaluation 31 and the image processing system 33. In particular, the elementary data types are completed by alarms, graphical data types, technical data types such as tables and image types such as video images, for example.

As explained above, the data record of an automation category 23 is basically divided into server- and client-related elements. The server-related elements or server elements 41, e.g. the control system 26, exist through the entire life of an individual copy of an automation category 23 or an object. The client-related elements or client elements 42, e.g. the display 28, on the other hand, are generated from scratch whenever a specific client-related function is required. Consequently, a plurality of client-related elements may exist simultaneously for a specific object whereas the server-related elements are permanent and there is only one per automation category or object.

The different data types also include specific attributes, which carry special properties between the automation elements 24 of an automation category 23 or an object or assume special tasks. To this end, a control variable is provided with a validity attribute, for example. The binary information of the validity attribute is always transported in conjunction with the actual value of the variable. By means of this validation mechanism or this validity attribute, the data source and a data sink also communicate with regard to the validity of a variable and the data sink is therefore able to adapt selectively to the prevailing conditions.

Furthermore, the numerical control variables may optionally have attributes of minimum value, maximum value and dimension so that these properties can be assumed without additionally having to set up other automation elements 24, e.g. from the user interface 29 or the data input 30. As a result, a push stick, for example, can be automatically adapted to the individual circumstances without the need for additional configuration resources.

The functions or automation elements 24 are managed in a category editor. The category editor is a graphics editor enabling different graphical and automation base elements to be combined.

The control 26 of an automation category 23 is the sum of all control base elements, such as function blocks and their logical link. In particular, the control system 26 is supported on generally known graphics languages and text languages. The control 26 may be operated on the host system or servers 9 to 11 within a PLC software program or in the external automation devices 3, 4 or distributed so as to be split on the PLC software program and the external automation devices 3, 4.

The key factor is that even if operation is divided between the PLC software and the external automation devices 3, 4, the program transfer from the host system or from the servers 9 to 11 to the external automation devices 3, 4 is structured so as to be transparent to the user. This is achieved by means of the automation categories 23 which, in addition to the control system 26, also contain the loading instructions for the external automation devices 3, 4.

The display 28 of an automation category 23 is the sum of all graphical elements which are arranged within a special graphics box. The graphics box is variable in size and may be set to any scale and rotated. The display 28 of an automation category 23 is run using different graphical elements, e.g. text, boxes, ellipses, polygons, lines or specific automation elements, such as trends, pipes, etc.

The user interface 29 of an automation category 23 is also made up of the sum of graphical elements which are arranged in another, special graphics box. By contrast with the display 28, which may occur only once per automation category 23, any number of user interfaces 29 may be defined for a specific automation category 23. In addition to graphical and automation base elements, the user interface 29 is also provided with operating elements such as switches, push sticks and the like as well as editable text fields.

A special binary data type “Alarm” is provided for the alarm system 27 of an automation category 23. This “Alarm” data type has various attributes, which determine which actions must be performed when an alarm occurs or is triggered or halted. For example, an entry may be made in a system log when an alarm occurs or different user groups advised.

In addition to the special “Alarm” data type, an entire project can be set up to have an automatic alarm configuration. To this end, the system searches through all the automation categories 23 or objects for alarm variables and classifies the result by user groups, priority, updatedness or the like. The alarm system 27 is basically a server-related element of an automation category 23. Operation of the alarm, on the other hand, is a client-related element.

The automation elements 24 relating to data input 30 and the data evaluation 31 are the data-related elements of an automation category 23 and are implemented by means of special basic elements. These include trends, tables or special databank function blocks. The log of historical changes in a variable represents a server-related element or server element 41. Its presentation, on the other hand, constitutes a client element 42.

The same applies to the logging of events in data banks. The log itself is server-related whilst the display of data in the corresponding tables is client-related. In the same way as the control 26, the data-related elements often communicate with external components, in particular data banks. The requisite intelligence is integrated in the respective automation category 23.

The configuration interface 32 of an automation category 23 is the sum of the graphical elements, which are arranged in a configuration box. The boxes are variable in size. The same basic elements available to the user interface 29 are also available to the configuration interface 32. The configuration interface 32 is available to the user of an automation category 23, typically an applications programmer, during the programming or configuration phase.

Another aspect involved in creating an automation category 23 is the simulation 34. If all automation categories 23 are provided with a simulation element, entire processes can be simulated with the minimum of effort. Switching between normal and simulated operation is effected by means of a control variable, to which all other automation elements 24 or functions respond and are set.

The documentation 35 of an automation category 23 is virtually automatically drafted during the course of the development process. In addition to text as the basic graphics element, the category editor supports an HTML basic category, by means of which a conventional online-help is available to the user of an automation category 23.

Clearly, within the scope of the invention, particularly if used for small technical systems, the hardware structure could be reduced to a minimum by using only one computer which would assume the client-server functions on a purely logical basis but in physical terms would consist of only one computer or a pair of computers.

For the sake of good order, it should finally be pointed out that in order to provide a clearer understanding of how the invention fits together, the function blocks have been illustrated in a very abstract form.

The independent tasks underlying the solutions proposed by the invention can be found in the description.

Above all, subject matter relating to the individual embodiments illustrated in FIGS. 1; 2, 3, 4 can be construed as independent solutions proposed by the invention. The tasks and solutions can be found in the detailed descriptions relating to these drawings.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An automation system for solving a process-related task definition or operating a technical system, comprising:
a computer system, which, in at least one field level with field bus components and automation devices, is broken down into a control level with at least one server and a client level with one or more client computers, the computer system including an automation category comprising system objects, said objects including at least one of physical system objects and part-processes, the automation category further comprising functions which incorporate said system objects in a process-related sequence, the automation category being developed within one standard context for different types of individual automation elements of an automated task and being developed on the basis of server-related data elements and client-related data elements, and wherein the automation elements are each compiled using server-related data elements, client-related data elements, and function elements, which are configured so as to optimize predetermined requirements of the automation elements.

2. The automation system as claimed in claim 1, wherein the server-related data elements are generated jointly with the automation category and remain fixed for the entire life of the automation category.

3. The automation system as claimed in claim 1, wherein the client-related data elements are created when and as needed during an operating time of the automation category and are specific to client elements of the automation category.

4. The automation system as claimed in claim 1, wherein server elements of the automation category exist permanently for the life of the automation category.

5. The automation system as claimed in claim 1, wherein client elements of the automation category are created and deleted when and as needed during an operating time of the automation category.

6. The automation system as claimed in claim 1, wherein a plurality of client elements of the automation category exist simultaneously.

7. The automation system as claimed in claim 1, wherein client elements of the automation category are linked to a corresponding pre-existing server element thereof as and when the client elements are created.

8. The automation system as claimed in claim 1, wherein individual automation elements are graphically and textually integrated in the automation category.

9. The automation system as claimed in claim 1, wherein the automation elements are defined via at least one of a control system, an alarm system, a display, a user interface, a data input, and a data evaluation system.

10. The automation system as claimed in claim 1, wherein the automation elements are each categorized as one of server elements and client elements depending on subsequent application, technical requirements, and execution thereof.

11. The automation system as claimed in claim 1, wherein the automation elements include automation elements relating to a control system and data input, and wherein the automation elements relating to the control system and data input constitute server elements.

12. The automation system as claimed in claim 1, wherein the automation elements include automation elements relating to a user interface, display , and data evaluation, and wherein the automation elements relating to the user interface, display, and data evaluation constitute client elements.

13. The automation system as claimed in claim 1, wherein programming means for functions are set up to cover automation elements.

14. The automation system as claimed in claim 1, wherein the function elements cooperate with the client-related data elements and the server-related data elements.

15. The automation system as claimed in claim 1, wherein subsidiary aspects of the automation elements are provided in the form of one or more of a configuration interface, an image processing system, a simulation, and documentation.

16. The automation system as claimed in claim 1, wherein the control level is provided with at least one server pair to provide a redundant structure.

17. A method of solving an automated task definition made up of automation elements of different types with the aid of a computer system comprising several hardware-related levels broken down into a control level having at least one server and a client level having one or more client computers, the method comprising:
solving the entire task definition on a template basis using an automation category for system objects and functions, said system objects including at least one of physical system objects and part-processes, wherein the functions incorporate the system objects in a process-related sequence, and wherein a category-specific data record is created in which, in addition to control data, at least one of data for a display and data for a user interface is also defined, all parts of the data record being defined within the context of the automation category and being categorized into server-related data elements and client-related data elements, and wherein each of the automation elements is compiled on the basis of the server-related data elements, client-related elements, and function elements made up of graphical and textual mechanisms designed to optimize predetermined requirements of the automation element.

18. The method as claimed in claim 17, wherein the data record is divided into server elements and client elements by reference to the different types of automation elements and physical devices.

19. The method as claimed in claim 17, wherein the data record is created in at least one of graphical and text format.

20. The method as claimed in claim 17, wherein all function elements of the automated task are solved within the context of the automation category and are also categorized as server-related function elements and client-related function elements.

21. The method as claimed in claim 17, wherein the automation category is published in a library.

22. The method as claimed in claim 21, wherein the library is provided so as to be accessible by network devices.

23. The method as claimed in claim 22, wherein a plurality of automation categories of different types are published in the library, and wherein the different types of automation categories of the library are made available to users via a global, network facility.

24. The method as claimed in claim 17, wherein automation projects are compiled from one or more individual copies of one or more automation categories and the structure of the data record and the functions of said automation categories are imported into each copy of the automation categories.

25. The method as claimed in claim 24, wherein the copies of the automation categories are linked to the automation project with a programming means that is also used to create the automation categories.

26. The method as claimed in claim 17, wherein several automation categories are in turn compiled to form a separate automation category and represent part-processes accordingly.

27. The method as claimed in claim 17, wherein the automation elements are categorized into server elements and client elements firstly on the basis of subsequent application thereof, then on the basis of technical requirements and execution thereof.

28. The method as claimed in claim 17, wherein the server elements exist for the entire life of the automation category and the client elements are created from scratch every time the respective function or the respective automation element is needed.

29. The method as claimed in claim 17, wherein each of the server elements exists permanently and once only per automation category and wherein at least one of the client elements exists on a multiple basis and simultaneously.
